(19) United States
(12) Patent Application Publication
(10) Pub. No.: US 2010/0056338 A1
(43) Pub. Date: Mar. 4, 2010

(54) Method for Compensating the Braking Deceleration in a Vehicle Control

(75) Inventor: Andreas Erban, Loechgau (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/227,747

(22) PCT Filed: May 23, 2007
(86) PCT No.: PCT/EP2007/055006

§ 371 Date: Nov. 10, 2009

(30) Foreign Application Priority Data
Jul. 7, 2006 (DE) 10 2006 031 511.1

(51) Int. Cl. B60W 10/18; B60W 30/02

(52) U.S. Cl. 477/203

(57) ABSTRACT

A method for stabilizing a vehicle in an extreme driving situation, in particular in an overcontrol or undercontrol of the vehicle, in which a vehicle controller intervenes in the driving operation by an automatic actuation of at least one wheel brake in order to stabilize the vehicle. The vehicle is able to be stabilized much more rapidly if an additional drive torque, which produces an additional yawing moment that augments the stabilizing effect of the braking intervention, is generated at at least one wheel.

### FIELD OF THE INVENTION

The present invention relates to a method and a vehicle controller for compensating the braking deceleration in a vehicle control.

### BACKGROUND INFORMATION

Vehicle controllers such as ESP or ABS improve the controllability of vehicles in critical driving situations, e.g., when overcontrolling or undercontrolling during cornering. As soon as a critical driving situation is detected these systems intervene in the vehicle operation, typically via the vehicle brakes, in an effort to stabilize the vehicle. In cornering during which the vehicle undercontrols, for example, a brake intervention at the rear wheel on the inside of the curve produces an additional yawing moment about the vehicle's vertical axis, which counteracts the undercontrolling and guides the vehicle back into the direction of the inside of the curve. The same analogously applies to the other rear wheel in the case of an overcontrolling vehicle.

Any automatic brake intervention results in a deceleration of the vehicle, in some instances a considerable deceleration. This is not always desired and in certain driving situations may have an adverse effect on driving safety.

### SUMMARY

An object of the present invention is to provide a vehicle control system as well as a corresponding method, by which the vehicle decelerates to a lesser degree in an automatic brake intervention.

An aspect of an example embodiment of the present invention is an automatic increase of the drive torque at at least one wheel of the vehicle and thus an at least partial compensation of the deceleration caused by the brake control. The additional drive torque is preferably applied in such a way that a yawing moment is generated, which augments the stabilizing effect of the automatic brake intervention. This provides the considerable advantage that the vehicle stabilizes more rapidly and in the process decelerates to a much lower degree. Furthermore, it makes it possible to set considerably higher brake torques at the wheel brakes, provided the road surface allows this, and to stabilize the vehicle more rapidly as a result.

For reasons of safety, an acceleration of the vehicle beyond the original velocity should be avoided, if possible, when increasing the drive torque. The drive torque should therefore be selected in such a way that the braking action of the vehicle controller is only partially compensated and, more particularly, is not overcompensated.

The amount of the additional drive torque is preferably limited to a maximum value. The maximum value may be a fixed value or may depend on a driving state variable, e.g., the vehicle speed. This makes it possible to limit the accident risk resulting from inappropriate acceleration.

The amount of the additional drive torque is preferably also a function of whether the vehicle is overcontrolling or undercontrolling. In a vehicle having front-wheel drive, the increase in the drive torque may cause increased wheel slip and thereby result in further destabilization of the driving behavior, especially if the vehicle is undercontrolling. The same must also be taken into account in the case of a vehicle having rear-wheel drive if the vehicle is overcontrolling. In this instance the additional drive torque must be reduced or suppressed completely.

According to a preferred specific embodiment of the present invention, an indicator for the instantaneous driving behavior of the vehicle, especially for the overcontrol or undercontrol behavior of the vehicle, is determined and the drive torque is applied to one wheel or a plurality of wheels as a function of this characteristic quantity. The indicator is preferably determined on the basis of the deviation between the setpoint and the actual yaw rate. The amount of the additional drive torque is thus dependent upon the degree of the overcontrolling or undercontrolling.

As an alternative or in addition, a sensor system may be provided, which monitors the wheel slip at the driven wheels. If the wheel slip exceeds a predefined threshold, the additional drive torque for this wheel is reduced accordingly.

The amount of the additional drive torque is preferably also a function of the vehicle speed. As a result, it is possible not to jeopardize the driving safety in certain driving situations in which no or only a slight additional drive torque may be applied, for example when parking or at very high driving speeds. According to one preferred specific embodiment, the compensation function according to the present invention is implemented only in a medium speed range. In contrast, at speeds that fall below a predefined threshold value, as well as at speeds that exceed a predefined threshold value, the compensation function is preferably deactivated.

The additional drive torque is preferably also a function of the driver input at the accelerator pedal. If the drive torque desired by the driver is greater than a predefined threshold value, e.g., 100 Nm, the calculated additional drive torque is applied in full. However, if the driver input is smaller than the threshold value, the additional drive torque is reduced further and further. If the driver is actually braking, preferably no additional drive torque will be applied.

The compensation function according to an example embodiment of the present invention is preferably implemented as software algorithm, which is stored in a control unit. The algorithm preferably calculates an engine torque which the drive of the vehicle is to generate in addition.

A vehicle control system according to an example embodiment of the present invention thus includes at least one control unit having a control algorithm, which in a brake control generates an additional drive torque, which augments the brake intervention in its stabilizing effect.

### BRIEF DESCRIPTION OF THE DRAWINGS

In the following, the present invention is explained in greater detail by way of example, with reference to the figures.

FIG. 1 shows a schematic block diagram of a vehicle control system having a function for increasing the drive torque in the event of a brake control.

FIG. 2 shows the main method steps of an example method for generating additional drive torque in a vehicle control.

### DETAILED DESCRIPTION OF EXAMPLE EMBODIMENTS

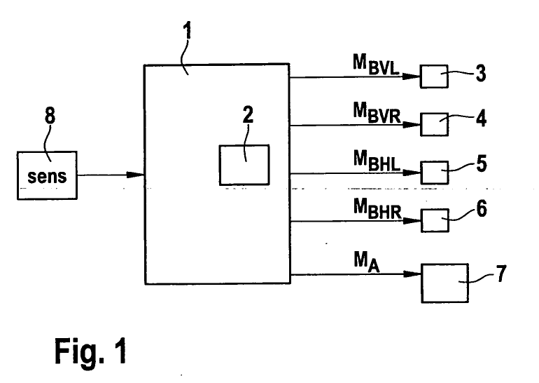

FIG. 1 shows a schematic block diagram of a vehicle control system, which implements an automatic brake intervention in a critical driving situation during which the vehicle overcontrols or undercontrols, for example, and which automatically increases the drive torque at at least one wheel at the same time. This allows an at least partial compensation of the deceleration resulting from the brake intervention. Furthermore, the stabilizing brake intervention is able to be implemented much more forcefully, so that higher yawing moments are generated, which stabilize the vehicle much more rapidly.

The system generally includes a control unit 1 in which a vehicle controller 2, e.g., ABS, is stored in the form of software. Control unit 1 is connected to a sensor system 8, which continuously monitors the instantaneous driving state with regard to various driving state variables. Sensor system 8 typically includes wheel-speed sensors, acceleration sensors, a yaw-rate sensor, etc. In addition, control unit 1 is connected to final controlling elements 3-6 of the individual wheel brakes and to engine control unit 7.

If the vehicle encounters a critical driving situation in which it over- or undercontrols, for example, this is detected by sensor system 8, and vehicle controller 2 generates a brake torque M_{B} for the individual wheel brakes. This produces a yawing moment about the vertical axis of the vehicle, which counteracts the yawing movement of the vehicle. Furthermore, vehicle controller 2 generates an additional drive torque M_{A} for at least one of the wheels, which at least partially compensates the braking deceleration. This additional drive torque, converted into an engine torque, is output to engine control unit 7.

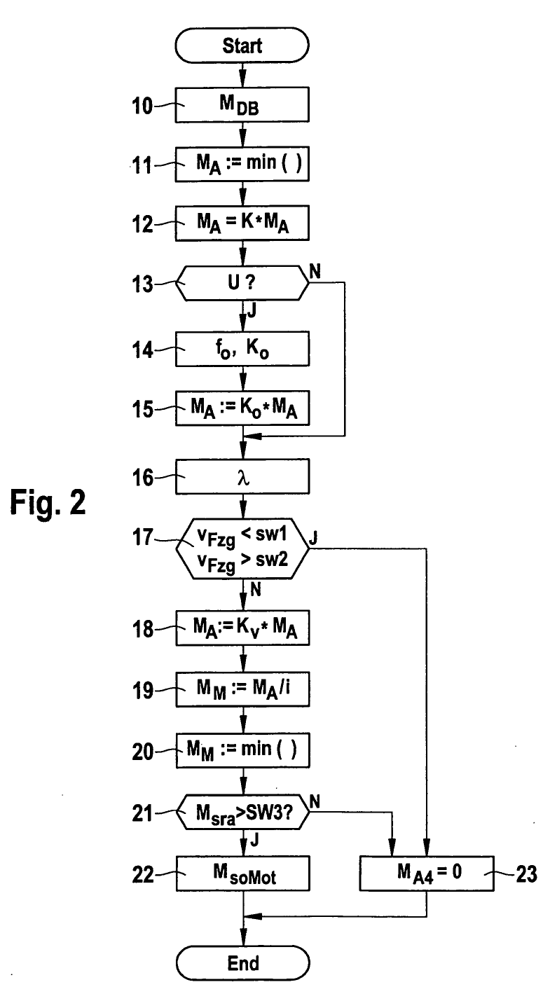

FIG. 2 shows the main method steps of an example method for determining additional drive torque M_{A}.

The automatic brake intervention generates a differential-braking torque M_{DB} at the front axle and/or rear axle, which causes a change in the yawing moment about the vertical axis. Initially, the following applies:

M_{DB}_{_{—}}ᵢₛₜ_{_{—}}_{VA}=M_{B}_{_{—}}_{VL}−M_{B}_{_{—}}_{VR} and

M_{DB}_{_{—}}ᵢₛₜHA=M_{B}_{_{—}}_{HL}−M_{B}_{_{—}}_{HR}.

Index VA represents the front axle, HA the rear axle, VL denotes front left, VR front right, HL rear left, and HR rear right. The total differential-braking torque M_{DB}_{_{—}}ᵢₛₜ induced by the automatic brake intervention results as:

M_{DB}_{_{—}}ᵢₛₜ=M_{DB}_{_{—}}ᵢₛₜ_{_{—}}_{VA}+M_{DB}_{_{—}}ᵢₛₜ_{_{—}}_{HA}.

Then, an at least partial compensation of this differential-braking torque M_{DB}_{_{—}}ᵢₛₜ is to take place by an additional drive torque M_{A}. To begin with, it is stipulated that additional drive torque M_{A} must not exceed instantaneous differential-braking torque M_{DB}_{_{—}}ᵢₛₜ or setpoint differential-braking torque M_{DB}_{_{—}}ₛₒₗₗ. This may be of particular importance in a control phase in which instantaneous differential-braking torque M_{DB}_{_{—}}ᵢₛₜ is able to follow setpoint differential-braking torque M_{DB}_{_{—}}ₛₒₗₗ only partially or with a delay. The following applies to the additional drive torque:

M_{A}=min (M_{DB}_{_{—}}ᵢₛₜ, M_{DB}_{_{—}}ₛₒₗₗ).

In addition, a maximum value M_{A}_{_{—}}ₘₐₓ is preferably specified for additional drive torque M_{A}. In this case the following applies to drive torque M_{A}:

M_{A}:=min (M_{A}, M_{A}_{_{—}}ₘₐₓ).

In step 12 it is determined which portion of differential-braking torque M_{DB}_{_{—}}ᵢₛₜ is to be compensated for by an increase in drive torque M_{A}. In this context the following applies:

M_{A}:=K*M_{A}.

Factor K is to be selected in a range between 0 . . . 1, a typical value being 0.7, for example.

Furthermore, in certain driving situations in which the vehicle is suddenly over- or undercontrolling, the additional drive torque must be reduced further so as not to worsen the power transmission of the driven wheels even further. For a vehicle having rear-wheel drive, as assumed in this exemplary embodiment, monitoring initially takes place as to whether the vehicle is suddenly overcontrolling (step 13). For this purpose, an overcontrol indicator Fₒ is determined in step 14, which is a function of the deviation of the setpoint torque from the instantaneous differential-brake torque. Overcontrol indicator fₒ is equal to zero, for example, when the vehicle is not overcontrolling, and it is equal to one if the vehicle is overcontrolling heavily. In addition, a limiting factor Kₒ is introduced as a function of overcontrol indicator fₒ. In step 15, the following function is then applied for drive torque M_{A}:

M_{A}:=Kₒ*M_{A}.

The same applies analogously to vehicles having front-wheel drive in a driving situation in which the vehicle is heavily undercontrolling all of a sudden. For vehicles having all-wheel drive, a combination of the measures for vehicles having rear-wheel drive and front-wheel drive is implemented.

In step 16, the wheel slip at the driven wheels is additionally monitored by sensors. If the wheel slip exceeds a specified threshold value, then the additional drive torque is reduced also.

The compensation function is also restricted to specified speed ranges in order to safeguard it from further potential faults. In particular, this is meant to prevent an unintentional increase in the drive torque at individual wheels in certain driving situations, for instance when the driver is parking. The same also applies to driving situations in which the vehicle is driving at a very high speed on a highway, for instance.

In step 17 it is first checked whether the vehicle speed is lower than a specified first threshold value SW1 or greater than a second threshold value SW2. In the speed range lying in-between, the function preferably remains fully active (case N). However, if vehicle speed V_{Fzg} is below first threshold value SW1 or above second threshold value SW2 (case J), then the function is preferably deactivated completely. In this case the following applies:

M_{A}:=0.

A linear increase or decrease in the particular transition range for M_{A} ensures the driving comfort.

Additional drive torque M_{A} calculated so far describes the drive torque at the wheel level. It is converted into a corresponding additional engine torque M_{M} in the following steps. Initially, the following applies to engine torque M_{M}:

M_{M}=M_{A}/i,

i being the effective torque transmission ratio (gearing, converter, differential) between wheel and engine. Furthermore, this additional engine torque M_{M} is restricted to a maximum value in step 20. The following applies in this context:

M_{M}=min (M_{M}, M_{M}_{_{—}}ₘₐₓ).

For safety-related reasons, this additional engine torque M_{M} is modified once more as a function of the driver input at the driving pedal (driving-pedal position). To this end, a limit factor K_{M} is calculated once again. This factor equals 1 if, for instance, the driver actuates the driving pedal and in so doing requests a drive torque that is greater than a specified threshold value SW3, e.g., 100 Nm. On the other hand, if the driver input is less than the minimum torque, then a continuous attenuation down to zero takes place. If the driver does not actuate the driving pedal, or if the driver brakes, limit factor K_{M} is preferably set to the zero value. Thus, the following applies to additional engine torque M_{M}:

M_{M}:=K_{M}*M_{M}.

Above the limit value, additional engine torque M_{M} is implemented in full. As soon as the driver is braking or is not actuating the driving pedal, or if vehicle controller 2 is inactive, no increase in the engine torque is allowed for reasons of vehicle dynamics or safety. In this case the following applies:

M_{M}=0.

In step 22, the increase in engine torque M_{M} is now also output in the form of an absolute setpoint engine torque Mₛₒₘₒₜ. In this context the following applies:

Mₛₒₘₒₜ=min (M_{Mmot}, M_{M}_{_{—}}_{Fahrer})+M_{M}.

The instantaneous engine torque is taken into account by M_{Mmot}. Should the need arise, this setpoint torque Mₛₒₘₒₜ may also be limited by external controllers, e.g., a traction control system.

1-14. (canceled)

15. A method for compensating braking deceleration resulting from a vehicle control in which a vehicle controller intervenes in the vehicle operation by automatic actuation of at least one wheel brake, comprising:
applying an additional drive torque at at least one driven wheel, so that the vehicle deceleration produced by the automatic brake intervention is at least partially compensated.

16. The method as recited in claim 15, wherein the additional drive torque is applied in such a way that a yawing moment is produced, which augments the stabilizing effect of the brake intervention.

17. The method as recited in claim 15, wherein the additional drive torque is dimensioned such that the deceleration produced by the automatic brake intervention is not overcompensated.

18. The method as recited in claim 15, wherein the additional drive torque is limited to a maximum value.

19. The method as recited in claim 15, wherein the additional drive torque is applied as a function of whether the vehicle is overcontrolling or undercontrolling.

20. The method as recited in claim 15, wherein the additional drive torque is applied as a function of a degree to which the vehicle is undercontrolling or overcontrolling.

21. The method as recited in claim 15, wherein the additional drive torque is applied as a function of whether the vehicle is driven by front-wheel drive, rear-wheel drive or all-wheel drive.

22. The method as recited in claim 21, wherein an overcontrol or undercontrol indicator is calculated from the deviation between the setpoint yawing rate and the actual yawing rate of the vehicle, and the drive torque is determined as a function of the overcontrol or undercontrol indicator.

23. The method as recited in claim 15, wherein the additional drive torque is applied as a function of a speed of the vehicle.

24. The method as recited in claim 15, wherein the additional drive torque is applied only in a medium speed range but not at low speeds below a specified first threshold value and at high speeds above a second threshold value.

25. The method as recited in claim 15, wherein wheel slip of one of the driven wheels is measured, and the additional drive torque is applied as a function of the measured wheel slip.

26. The method as recited in claim 15, wherein the additional drive torque is converted into an engine torque and forwarded to an engine control.

27. A device for stabilizing a vehicle in an overcontrol or undercontrol of the vehicle, comprising:
an electronics system adapted to compensate braking deceleration resulting from a vehicle control in which a vehicle controller intervenes in vehicle operation by actuation of at least one wheel brake, the electronic system adapted to apply an additional drive torque at at least one driven wheel, so that the vehicle decelerator produced by the automatic intervention is at least partially compensated.

28. The device as recited in claim 27, wherein the electronics system is a control unit.
